(19) United States
(12) Patent Application Publication
(10) Pub. No.: US 2002/0061831 A1
(43) Pub. Date: May 23, 2002

(54) Effervescent toilet bowl sanitizer tablet

(75) Inventors: Andrew James Kaziska, Whitehouse Station, NJ (US); Joseph William Scheblein, Flemington, NJ (US); Paul Martin Doe, Indianapolis, IN (US)

Correspondence Address: DARBY & DARBY P.C., 805 Third Avenue, New York, NY, 10022, US

(73) Assignee: Lonza Inc.

(21) Appl. No.: 09/943,427

(22) Filed: Aug. 28, 2001

Related U.S. Application Data
(63) Continuation of application No. PCT/US00/35718, filed on Dec. 29, 2000.
(60) Provisional application No. 60/173,841, filed on Dec. 30, 1999.

(51) Int. Cl. C11D 17/00

(52) U.S. Cl. 510/446

(57) ABSTRACT

An effervescent sanitizing and cleaning tablet is provided in tablet form. The ingredients include an alkaline solid of a fine powder particle size and a granular acid solid which in the presence of water react to generate carbon dioxide gas; a quaternary ammonium compound; and an inert filler to provide a tablet that sinks and dissolves quickly in water.

### FIELD OF THE INVENTION

The present invention relates to a quick-dissolving biocidal and cleanser tablet for sanitizing water. A specific application for the tablet is sanitizing and cleaning a toilet bowl.

### BACKGROUND OF THE INVENTION

Toilet cleanser or disinfectant compositions are typically packaged as multi-compartment formulations. These formulations generally require a separate holder in the tank for the formulation and/or an actuating means for release of the active components. Active components may be packaged separately in envelopes or sachets or tablets, and are placed in separate compartments of devices that are installed in toilet bowl tanks or under toilet bowl rims. The devices are activated, and active components are mixed, upon agitation by water or mechanical force. They may be multi-step in action or the ingredients may be released at the same time. Often they work by slow release of materials into the bowl water to provide a cleansing effect over an extended period of time. Compositions useful as cleaners are also often in liquid form. Liquid cleaners are placed in the tank of the toilet and washed through the bowl upon flushing. Other products consist of granular compositions which may be sprinkled on the bowl water surfaces.

A desirable alternative to a product requiring holders or mechanical means to clean and sanitize all areas of the bowl, including the bowl bottom, is a quick-acting multifunctional one-step toilet bowl sanitizer and cleanser. Preferably the composition will be in solid form, preferably as a tablet, which provides convenience for consumer handling. However, the preparation of a convenient-to-use quick-acting multifunctional one-step toilet bowl sanitizer and cleanser in solid form is hampered by problems with packaging the required active ingredients in a single composition such that the components remain stable and unreactive until placed into a water environment.

Multi-functional sanitizing and cleansing compositions typically contain a biocidal agent as the sanitizing component, as well as other active components that provide detergency and cleaning properties. Commercially available toilet bowl sanitizers often utilize oxidizing reagents for biocidal activity which, however produce undesirable gases and odors. For example, halogen releasing compounds generate HOCl as the primary biocidal ingredient. Solid compositions containing a biocidal agent and other ingredients required for cleansing become unstable due to the combination of chemically sensitive components. Clearly, an effective sanitizing and cleansing product that is convenient and safe for consumer handling and use is not easily attainable.

Additional problems arise with solid formulations such as tablets, namely integrity, fragmentation and release of chemicals in a non-uniform manner. A solid multi-functional composition having sufficient integrity to remain whole, without fracturing, during packaging, transport and consumer handling, yet be capable of dissolving completely, quickly and uniformly releasing its active ingredients, has not heretofore been easily obtained.

### SUMMARY OF THE INVENTION

The present invention provides a tablet for one-step sanitization and cleaning of the water and surfaces in a water reservoir, such as a toilet bowl.

The tablet comprises a surface active biocidal agent, preferably a quaternary ammonium compound. The tablet also comprises an alkaline compound and an acid compound, wherein the alkaline and acid compounds react in the presence of water to produce gas, i.e., effervesce. The alkaline compound is used in a fine powder particle size wherein not more than 25% of the particles is retained on a No. 140 U.S. Standard Sieve, and preferably at least 35% of the particles goes through a No. 325 U.S. Standard Sieve. The acid compound is granular and has a particle size wherein at least 75% of the particles is retained on a No. 50 U.S. Standard Sieve, and preferably wherein not more than 1% of the particles is retained on a No. 16 U.S. Standard Sieve. The tablet also comprises a water soluble inert filler.

The cleaning and sanitizing tablet of the present invention further comprises binders and/or hardeners and lubricants. The tablet may also include disintegration aids. The tablet may further include a dye and a perfume for enhancement of consumer appeal.

The present invention unexpectedly provides the desired properties in a combination of ingredients formed into a tablet as described herein. The solid tablet formulation is fast acting, that is the ingredients are activated immediately upon delivery into the bowl water and are substantially dissolved in the bowl water in less than 3 minutes.

The particle sizes of the alkaline compound and the acid compound are chosen such that, when combined with the surface active biocidal agent and the filler in tablet form, the tablet will sink below the surface of the bowl water. The tablet remains submerged until it is substantially dissolved, preferably in less than three minutes, after being delivered into the bowl water.

### DETAILED DESCRIPTION OF THE INVENTION

The amounts of the components of the tablet of the present invention, shown as weight % based on 100% total weight of the tablet, are provided in Table 1 below.

TABLE 1

| | | Broad wt. % | Preferred wt. % |
|---|---|---|---|
| Component | Function | Range | Range |
| Quaternary | Biocide & | 2-15 | 6-10 |
| ammonium | Surfactant | | |
| Alkaline | Effervescence | 25-50 | 30-45 |
| Acid | Effervescence | 15-35 | 20-30 |
| Inert salt | Filler | 5-30 | 12-22 |
| Polyethylene glycol | Binder | 0.5-5 | 1-3 |
| | Lubricant | | |
| Sorbitol | Hardener | 0.75-7 | 1.5-5 |
| Other | Dye | 0-2 | 0.5-1.5 |
| | Perfume | 0-1 | 0.5-0.8 |

A first component of the tablet of the present invention comprises a non-oxidizing biocidal compound, such as a cationic surface active agent. The cationic surface active agents which have been found to be particularly advantageous for use in the present invention are quaternary ammonium compounds.

The quaternary ammonium compounds have the formula

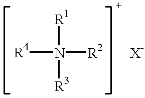

wherein R¹ and R² are independent C₁-C₆ alkyl or hydroxyalkyl, R³ and R⁴ are independently linear or branched C₈-C₃₀ alkyl or C₆-C₂₀ aryl-substituted alkyl, and X is an anion. Preferably, R¹ and R² are independently C₁-C₃ alkyl or hydroxyalkyl and more preferably methyl. R³ is preferably a linear or branched C₈-C₈ alkyl or benzyl. R⁴ is preferably a linear or branched C₈-C₁₈ alkyl. X is preferably a halogen, carbonate, phthalate, or propionate and more preferably chloride, carbonate, or propionate. Two classes of quaternary ammonium compounds suitable for the tablet are alkyl dimethylbenzyl ammonium chlorides (ADBACs) and dialkyl dimethyl ammonium chlorides (DIDACs).

Preferred quaternary ammonium compounds include, but are not limited to, didecyldimethyl ammonium chloride available; (C₁₂-C₁₈) alkyl dimethyl benzyl ammonium chloride; diisobutylphenoxy-ethoxyethyl dimethyl benzyl ammonium chloride; didecylmethyl poly(oxyethyl) ammonium propionate, and any combination of the foregoing. More preferably, the quaternary ammonium compound is (C₁₂-C₁₈) alkyl dimethyl benzyl ammonium chloride, (C₁₂-C₁₆) alkyl dimethyl benzyl ammonium chloride (C₁₄ 95%, C₁₂ 3% and C₁₆ 2%) or alkyl dimethyl benzyl ammonium chloride (C₁₄ 50%, C₁₂ 40% and C₁₆ 10%).

Members of this class of agents are especially preferred for inclusion in the present sanitizing and cleaning tablet since these agents are also surfactants which act to foam the bowl contents upon generation of the carbon dioxide gas generated by the alkaline and acid compounds. In its capacity as a surfactant, the biocidal agent should be present in the tablet in an amount sufficient to form foam in the bowl water and to cleanse the bowl surfaces that it contacts. The generation of foam is desirable as an indicator to the consumer of the cleaning action of the composition.

The quaternary ammonium compound is present in the tablet in an amount to yield a final concentration in the bowl water of the quaternary ammonium compound of broadly from about 150 ppm to 450 ppm, preferably about 200 ppm to 300 ppm.

A second component of the present invention is an alkaline compound. The alkaline compound reacts with the acid component in the presence of water to liberate a gas, typically carbon dioxide, and to provide effervescence. The alkaline compound is in solid form, preferably in the form of particles. Examples of alkaline compounds are sodium bicarbonate, potassium carbonate, ammonium bicarbonate, ammonium carbonate, sodium carbonate, and potassium bicarbonate and other water soluble carbonate and bicarbonate salts.

A third component of the tablet of the present invention is an acid compound. The acid employed in the present invention is capable of reacting with the alkaline compound in the presence of water to produce effervescence. The acid is solid at room temperature. Suitable acids are organic acids such as water soluble carboxylic acids and acid salts thereof. Examples of acids include citric acid, tartaric acid, adipic acid and oxalic acid.

In the invention, the tablet comprises the alkaline material in fine powder form and the acid compound in granular form.

In the case of the alkaline compound a fine powder material is used. It has a particle size wherein not more than 25% of the particles is retained on a No. 140 U.S. Standard Sieve, and at least 35% of the particles goes through a No. 325 U.S. Standard Sieve. Preferably, the fine powder alkaline material has a particle size wherein not more than 5% of the particles is retained on a No. 140 U.S. Standard Sieve, and at least 50% of the particles goes through a No. 325 U.S. Standard Sieve.

With respect to the acid compound, a granular particle size is used wherein at least 75% of the particles is retained on a No. 50 U.S. Standard Sieve and not more than 1% of the particles is retained on a No. 16 U.S. Standard Sieve. Preferably, the granular acid compound has a particle size wherein 90% of the particles is retained on a No. 50 U.S. Standard Sieve and not more than 1% of the particles is retained on a No. 16 U.S. Standard Sieve.

Stoichiometric amounts of the alkaline and acid compounds are used to optimize the formation of carbon dioxide in the water. Although the alkaline and acid compounds are desirable in stoichiometric ratios, a greater or lesser amount of such components may not be detrimental to the overall performance of the tablet.

The ratio of the total amount of alkaline and acid compounds to the total weight of the tablet of the invention is broadly about 1:2.5 to 1:1.2 and preferably about 1:2 to 1:1.3. The ratio will vary, however, depending upon the alkaline and acid compounds selected. It has been found that these amounts generate sufficient carbon dioxide to agitate the bowl water to accelerate the dissolution of the tablet to enhance the cleaning and sanitizing capacity of the tablet.

The tablet of the invention also includes a water-soluble inert filler. The inert filler adds density to the tablet. The filler also enhances the dissolution of the tablet. The density of a tablet of the present invention will vary according to the size of the tablet, the amount of ingredients such as the hardeners, disintegration aids and binder, and on the compression pressure used to form the ingredients into a tablet. For a tablet that is about 4.0 cm in diameter and 0.5 cm in width and weighs about 10 g, the density of the tablet is typically about 1.45 g/cm³.

The inert filler is present in an amount so that the tablet submerges, rather than floats, in the bowl water, and remains submerged until the tablet has substantially dissolved, i.e., until a crescent-shaped residual portion remains and/or floats to the water surface. The tablet of the present invention dissolves in less than 3 minutes, and preferably in less than 2 minutes, after being immersed in the bowl water. In a preferred embodiment, the tablet dissolves in about 100 seconds. Further, the candidate inert filler should not interfere with the processing of the ingredients into a tablet.

Suitable fillers are water-soluble inert salts, such as water-soluble inorganic or organic salts (or mixtures of such salts). Examples include various alkali metal and/or alkaline earth metal sulfates, chlorides, borates and citrates. Specific inert salts which may be selected include sodium sulfate, calcium sulfate, sodium chloride, potassium sulfate, sodium carbonate, lithium chloride, tripotassium phosphate, sodium bromate, potassium fluoride, sodium bicarbonate, calcium chloride, magnesium chloride, sodium citrate, magnesium sulfate and sodium fluoride.

It is also desirable that the tablet contain a lubricant. A suitable lubricant can facilitate the tableting process and provide for a finished product having a relatively smooth surface. Lubricants can include magnesium stearate, calcium stearate, polyethylene glycols such as Carbowax®, leucine and glycerol behenate.

To increase or maintain the physical integrity of the particles, especially during handling, a binder or hardener should also be added to the tablet. The binder or hardener should be compatible with the active ingredients and facilitate the tableting process. Materials that are suitable as binders or hardeners include ethylcellulose, methylcellulose, guar gum, polyvinylpyrrolidone/vinyl acetate copolymer, microcrystalline cellulose, soy polysaccharide, pre-gelatinized starches, polyethylene glycols and crystalline sorbitol. Preferably the hardener is sorbitol.

The tablet also optionally includes a disintegration aid. Suitable disintegration aids include polyvinylpyrrolidone, calcium carboxymethyl cellulose, bentonite clay and microcrystalline cellulose.

The hardness of the tablet will depend on the curing time of the tablet, therefore the amount of hardener, binder or disintegrant added to the tablet of the invention will vary in relation to the aging process of the tablet. For example, if the tablet undergoes accelerated curing, less hardener may be required and more disintegrant may be added to achieve a tablet that dissolves in the desired time period. Consideration should also be given to minimizing the exposure of the ingredients and tablet to the deleterious effects of moisture which may prematurely cause dissolution or effervescence of the ingredients in the tablet.

Further examples of the above ingredients that may be suitable for the present invention are provided in Handbook of Industrial Chemical Additives, (Michael and Irene Ash, eds.) 2nd Edition, Vols.2 and 3, Synapse Information Resources, Inc. (1998).

The tablet also optionally contains a fragrance to enhance consumer appeal and to mask bowl odors. Fragrances are typically oil based materials, and thus should be employed in amounts compatible with the agents in particulate form and not be detrimental to the tableting process. Since the ingredients in the tablet of the invention are non-oxidizing, a wide variety of fragrances can be used.

Examples of perfumes or fragrances include naturally occurring oils and fragrances and synthetic equivalents thereof, for example ambergris, bergamot oil, benzoin oil, castoreum, civet, clove leaf oil, eucalyptus, geranium oil, jasmine absolute, lavender, grapefruit oil or fragrance, citrus fruit oil or fragrance, lemon grass oil, myrrh, mush tonquin, mimosa, rose oil, rosemary oil, or sandalwood oil or synthetic aroma chemicals, for example benzyl acetate, citronellol, geraniol, linalool, must ambrette, or terpene hydrocarbons. Suitable fragrances are disclosed by in Cosmetics—Science and Technology, E. Sagarin, John Wiley and Sons, NY (1957).

It is also desirable, though not essential, to include a colorant such as a pigment or dye. Preferably a dye is used which is water soluble. Examples of suitable dyes include FD & C Blue No 1, Ultramarine Blue, Copper Phthalocyanine, Acid Blue No. 9, Carta Blue V (C.I. 24401), Acid Green 2G (C.I. 42085), Astragon Green D (C.I. 42040), Maxilon Blue, 3RL (C.I. Basic Blue 80), Drimarine Blue Z-RL (C.I. Reactive Blue 18) and other Acid Blue 9 type dyes.

The tablet of the invention is useful for sanitizing a volume of water contained in a water reservoir used in personal care environments such as toilet bowl water, bath tub water and spa water, or in environments where sanitized water is desired to minimize the transmission of infection or bacteria on hard surfaces. The amounts of the active components contained in the tablet provide effective concentrations of the active components when the tablet is dissolved in the volume of the water to be sanitized.

The amounts of the active compounds in the tablet depend upon the size and weight of the tablet. The size and weight of the tablet is determined by the volume of water into which the tablet is delivered.

The tablets of the present invention may be prepared by standard tableting processes. The tablets may be formed by blending all ingredients to provide a homogeneous blend and compressing the mixture into tablets. Compression pressure is typically about 5,000 to 15,000 lbs. The compression force used is adequate to form a tablet, but not so great as to alter the desired particulate size required for quick dissolution and non-buoyancy.

The tablets of the present invention may also be prepared by first mixing all of the ingredients except the quaternary ammonium salts, and the quaternary ammonium salts may be blended into the mixture before compacting the particles into a tablet. The tablet may then be further coated with other excipients as required or desired for packaging.

The following Example illustrates more specifically the invention. It will be understood that while the invention as described therein is a specific embodiment thereof, the description above and the example are intended to illustrate and not limit the scope of the invention. Other aspects, advantages and modifications within the scope of the invention will be apparent to those skilled in the art to which the invention pertains.

All patents, patent applications, and other publications cited herein are incorporated by reference in their entireties.

### EXAMPLE

This example illustrates a method for preparing a sanitizing and cleansing tablet according to the present invention. The ingredients for making the tablet are set out below in Table 2.

TABLE 2

| | | % of total | weight |
|---|---|---|---|
| Ingredient | Function | weight | (g) |
| Sodium bicarbonate | effervescence | 41.5 | 4.15 |
| Citric acid | effervescence | 26 | 2.6 |
| Alkyl dimethyl benzyl | sanitizer | 7.5 | 0.75 |
| ammonium chloride | detergent | | |
| (C₁₄ 50%, C₁₂ 40% | foam | | |
| and C₁₆ 10%) | | | |
| Sodium Chloride | increase density and | 19 | 1.9 |
| | solubility | | |
| Carbowax 8000 | binder/lubricant | 2.0 | 0.2 |
| Sorbitol (crystalline) | tablet hardener | 3.0 | 0.3 |
| Dye/perfume | consumer appeal | 1.0 | 0.1 |

All the ingredients shown in Table 2 were mixed until a homogeneous blend was formed. The blended ingredients were then placed in a Carver press where 5,000-15,000 lbs. was applied for 5-10 seconds to form a 10 g tablet which was 4.0 cm in diameter and 0.5 cm in thickness and had a density of 1.45 g/cm³.

In order to illustrate that the particle sizes of the alkaline and acid components of the present invention provided a formulation having the required rapid dissolution time of less than three minutes, several sample tablets were prepared as described above, wherein the samples contained varying particle sizes of the acid and alkaline components. The various particle sizes in the samples are shown in Table 3 below. The combinations of particle sizes in each sample are shown in Table 4. The tablets were placed in water and the dissolution of the tablets was observed.

TABLE 3
Citric acid

| | |
|---|---|
| fine | Maximum of 1% is retained on a No. 30 U.S. Standard Sieve |
| granular | Maximum of 10% goes through a No. 100 U.S. Standard Sieve |
| granular | Maximum of 1% is retained on a No. 16 U.S. Standard Sieve |
| | Maximum of 10% goes through a No. 50 U.S. Standard Sieve |

Sodium bicarbonate

| | |
|---|---|
| fine | 0-<1% is retained on a No. 100 U.S. Standard Sieve |
| powder | 0-5% is retained on a No. 140 U.S. Standard Sieve |
| | 0-20% is retained on a No. 200 U.S. Standard Sieve |
| | 0-50% is retained on a No. 325 U.S. Standard Sieve |
| coarse | 0-8% is retained on a No. 60 U.S. Standard Sieve |
| granular | 0-35% is retained on a No. 70 U.S. Standard Sieve |
| | 0-100% is retained on a No. 100 U.S. Standard Sieve |
| | 0-100% retained on No. 170 U.S. Standard Sieve |

TABLE 4

| | Citric acid | Na Bicarbonate |
|---|---|---|
| Sample | (particle size) | (particle size) |
| 1 | fine granular | fine powder |
| 2 | granular | coarse granular |
| 3 | fine granular | coarse granular |
| 4 | granular | fine powder |

In Sample 1, the formulation contained smaller particle size citric acid and sodium bicarbonate. Sample 1 had a dissolution time of 337 seconds. In the formulation of Sample 2, both the citric acid and sodium bicarbonate were present in larger particle size. The tablet of Sample 2 dissolved in 315 seconds. The formulation of Sample 3, which contained smaller particle size citric acid and larger particle size sodium bicarbonate, had a dissolution time of 425 seconds. The formulations of Samples 1, 2 and 3 were unsatisfactory in meeting the criterion of the invention since their dissolution times were in excess of three minutes.

The formulation of the preferred embodiment of the invention, Sample 4, contained citric acid of larger particle size and sodium bicarbonate of smaller particle size. The tablet of Sample 4 completely dissolved in 100 seconds. These results demonstrated that the formulation of Sample 4 fully met the criterion of the invention.

What is claimed is:

1. A tablet for cleaning and sanitizing comprising a biocidal agent, an alkaline compound and an acid compound which in the presence of water react to produce gas, and a water-soluble inert filler, said alkaline compound having a particle size wherein not more than 25% of the particles is retained on a No. 140 U.S. Standard Sieve and at least 35% of the particles goes through a No. 325 U.S. Standard Sieve; and said acid compound having a particle size wherein at least 75% of the particles is retained on a No. 50 U.S. Standard Sieve and not more than 1% of the particles is retained on a No. 16 U.S. Standard Sieve, said tablet being capable of dissolving in an aqueous medium in less than 3 minutes.

2. The tablet of claim 2, wherein said alkaline compound has a particle size wherein not more than 5% of the particles is retained on a No.140 U.S. Standard Sieve, and wherein said acid compound has a particle size wherein at least 75% of the particles is retained on a No. 50 U.S. Standard Sieve.

3. The tablet of claim 1, comprising 2 to 15 weight % of the biocidal agent; 25 to 50 weight % of the alkaline compound; 15 to 30 weight % of the acid compound; and 5 to 30 weight % of the filler.

4. The tablet of claim 1, wherein the biocidal agent is a cationic surface agent.

5. The tablet of claim 4, wherein the cationic surface active agent is alkyldimethylbenzyl ammonium chloride or alkyldimethyl ammonium chloride.

6. The tablet of claim 1, wherein the alkaline compound is sodium bicarbonate, potassium carbonate, ammonium bicarbonate, ammonium carbonate, sodium carbonate or potassium bicarbonate.

7. The tablet of claim 1, wherein the acid is a carboxylic acid.

8. The tablet of claim 7, wherein the acid is citric acid, tartaric acid, oxalic acid, adipic acid or mixtures thereof.

9. The tablet of claim 1, wherein the filler is an inert salt.

10. The tablet of claim 9, wherein the salt is sodium sulfate, calcium sulfate, sodium chloride, potassium sulfate, sodium carbonate, lithium chloride, tripotassium phosphate, sodium bromate, potassium fluoride, sodium bicarbonate, calcium chloride, magnesium chloride, sodium citrate, magnesium sulfate or sodium fluoride.

11. The tablet of claim 1, further comprising a dye.

12. The tablet of claim 1, further comprising a perfume or fragrance.

13. The tablet of claim 1, further comprising a lubricant.

14. The tablet of claim 1, further comprising a binder.

15. A tablet for cleaning and sanitizing comprising a biocidal agent, a fine powder alkaline compound and a granular acid compound which in the presence of water react to produce gas, and a water-soluble inert filler, said tablet being capable of dissolving in an aqueous medium in less than 3 minutes.

16. The tablet of claim 15, wherein said alkaline compound has a particle size wherein not more than 5% of the particles is retained on a No.140 U.S. Standard Sieve, and wherein said acid compound has a particle size wherein at least 75% of the particles is retained on a No. 50 U.S. Standard Sieve.

17. A toilet bowl sanitizer comprising alkyl dimethyl benzyl ammonium chloride, sodium bicarbonate, citric acid and sodium chloride, said sodium bicarbonate having a particle size wherein not more than 5% of the particles is retained on a No.140 U.S. Standard Sieve, and said citric acid having a particle size wherein at least 75% of the particles is retained on a No. 50 U.S. Standard Sieve, said sanitizer being capable of dissolving in an aqueous medium in less than 2 minutes.

18. A method for sanitizing water in a water reservoir comprising adding to the water a tablet comprising a biocidal surface active agent, an alkaline compound and an acid compound which in the presence of the water react to produce carbon dioxide, and a water soluble inert filler, said alkaline compound having a particle size wherein not more than 25% of the particles is retained on a No. 140 U.S. Standard Sieve, and at least 35% of the particles goes through a No. 325 U.S. Standard Sieve, and said acid compound having a particle size wherein at least 75% of the particles is retained on a No. 50 U.S. Standard Sieve, and wherein not more than 1% of the particles is retained on a No.16 U.S. Standard Sieve; said tablet being capable of dissolving in an aqueous medium in less than 3 minutes.
